(19) United States
(12) Patent Application Publication
(10) Pub. No.: US 2010/0162353 A1
(43) Pub. Date: Jun. 24, 2010

(54) TERMINAL AUTHENTICATION APPARATUS AND METHOD IN DOWNLOADABLE CONDITIONAL ACCESS SYSTEM

(75) Inventors: Han Seung KOO, Daejeon (KR); Woongshik YOU, Chungcheongnam-do (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/613,630

(22) Filed: Nov. 6, 2009

(30) Foreign Application Priority Data
Dec. 22, 2008 (KR) 10-2008-0130897

(51) Int. Cl. H04L 9/32

(52) U.S. Cl. 726/2

(57) ABSTRACT

A terminal authentication apparatus and method in a Downloadable Conditional Access System (DCAS) is provided. The terminal authentication method may determine whether terminal authentication information, received from a DCAS terminal, is valid by referring to a database, may transmit DCAS image information and pairing information about the terminal authentication information to a user terminal, when the terminal authentication information is valid, and thereby may enable the DCAS terminal to set the user terminal based on the pairing information.

### CROSS-REFERENCE TO RELATED APPLICATION

This application claims priority from Korean Patent Application No. 10-2008-0130897, filed on Dec. 22, 2008, in the Korean Intellectual Property Office, the entire disclosure of which is incorporated herein by reference.

### BACKGROUND OF THE INVENTION

1. Field of the Invention

The present invention relates to a terminal authentication apparatus and method in a Downloadable Conditional Access System (DCAS), and more particularly, to a terminal authentication apparatus and method in a DCAS that may operate a Trusted Authority (TA) function in a Multiple System Operator (MSO) in the DCAS.

2. Description of Related Art

A Downloadable Conditional Access System (DCAS) may enable a cable subscriber to purchase, at a retail store, a Set Top Box (STB) without regard to a subscribed Multiple System Operator (MSO) the cable subscriber subscribes to. Also, even when the cable subscriber changes an MSO, a DCAS may enable a cable subscriber to be continuously provided with a fee-based cable service without replacing an STB.

Also, a DCAS may enable a cable service provider to replace a Conditional Access System (CAS) with another system without a replacement of a previously distributed STB.

The above-described DCAS is to enable an MSO to securely download images of application programs requiring a security system to a Secure Micro (SM) which is a security chip of an STB. For example, the application programs may include a CAS application, a Digital Right Management (DRM) application, and an Authorized Service Domain (ASD) application. Also, the DCAS is to enable the MSO, while on-line, to install and replace the CA application, the DRM application, and the ASD applications.

In a conventional art, however, when a DCAS is applied, a subscriber is required to obtain authentication of a plurality of MSOs. Also, for the authentication, a security authentication through an external Trusted Authority (TA) providing a TA function is required whenever an application is accessed, which is inconvenient.

### SUMMARY OF THE INVENTION

According to an aspect of the present invention, there is provided a terminal authentication apparatus in a Downloadable Conditional Access System (DCAS), the terminal authentication apparatus including: a first receiving unit to receive terminal authentication information from at least one user terminal; a determination unit to determine whether the terminal authentication information is valid by referring to a database; and a first transmission unit to transmit DCAS image information and pairing information about the terminal authentication information to the at least one user terminal, when the terminal authentication information is valid.

According to another aspect of the present invention, there is provided a terminal authentication apparatus in a DCAS, the terminal authentication apparatus including: a first receiving unit to receive terminal authentication information from at least one user terminal; a first determination unit to determine whether the terminal authentication information is valid by referring to a first database; a validity verification request unit to request a Multiple System Operator (MSO) for a validity verification of the terminal authentication information, when the terminal authentication information is invalid, the MSO corresponding to the terminal authentication information; and a first transmission unit to transmit DCAS image information and pairing information about the terminal authentication information to the at least one user terminal, when validity verification information is received from the MSO, the validity verification information determining that the terminal authentication information is valid.

The MSO may further include: a second receiving unit to receive the terminal authentication information; a second determination unit to determine whether the terminal authentication information is valid by referring to a second database; and a second transmission unit to transmit the validity verification information to the first receiving unit, when the terminal authentication information is valid.

According to an aspect of the present invention, there is provided a terminal authentication method in a DCAS, the terminal authentication method including: transmitting terminal authentication information by at least one user terminal to an MSO; determining whether the terminal authentication information is valid by referring to a database by the MSO; transmitting DCAS image information and pairing information about the terminal authentication information by the MSO to the at least one user terminal, when the terminal authentication information is valid; installing the received DCAS image information in the at least one user terminal; and setting the at least one user terminal based on the pairing information.

According to another aspect of the present invention, there is provided a terminal authentication method in a DCAS, the terminal authentication method including: transmitting terminal authentication information by at least one user terminal to a first MSO; determining whether the terminal authentication information is valid by referring to a first database of the first MSO; requesting a second MSO for a validity verification of the terminal authentication information, when the terminal authentication information is invalid, the second MSO corresponding to the terminal authentication information; determining whether the terminal authentication information is valid by referring to a second database of the second MSO; transmitting validity verification information by the second MSO to the first MSO, when the terminal authentication information is valid, the validity verification information determining that the terminal authentication information is valid; transmitting DCAS image information and pairing information about the terminal authentication information by the first MSO to the at least one user terminal, when the validity verification information is received; installing the received DCAS image information in the at least one user terminal; and setting the at least one user terminal based on the pairing information.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating an example of a basic configuration of a Downloadable Conditional Access System (DCAS) according to an embodiment of the present invention;

FIG. 2 is a diagram illustrating an example of registration and distribution of a DCAS terminal according to an embodiment of the present invention;

FIG. 3 is a diagram illustrating a configuration of a terminal authentication apparatus in a DCAS according to an embodiment of the present invention;

FIG. 4 is a diagram illustrating a configuration of a Multiple System Operator (MSO) of the terminal authentication apparatus of FIG. 3;

FIG. 5 is a diagram illustrating a configuration of a user terminal of the terminal authentication apparatus of FIG. 3;

FIG. 6 is a diagram illustrating a configuration of a terminal authentication apparatus in a DCAS according to another embodiment of the present invention;

FIG. 7 is a diagram illustrating a configuration of a first MSO of the terminal authentication apparatus of FIG. 6;

FIG. 8 is a diagram illustrating a configuration of a second MSO of the terminal authentication apparatus of FIG. 6;

FIG. 9 is a diagram illustrating a configuration of a user terminal of the terminal authentication apparatus of FIG. 6;

FIG. 10 is a flowchart illustrating a terminal authentication method in a DCAS according to an embodiment of the present invention; and

FIG. 11 is a flowchart illustrating a terminal authentication method in a DCAS according to another embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

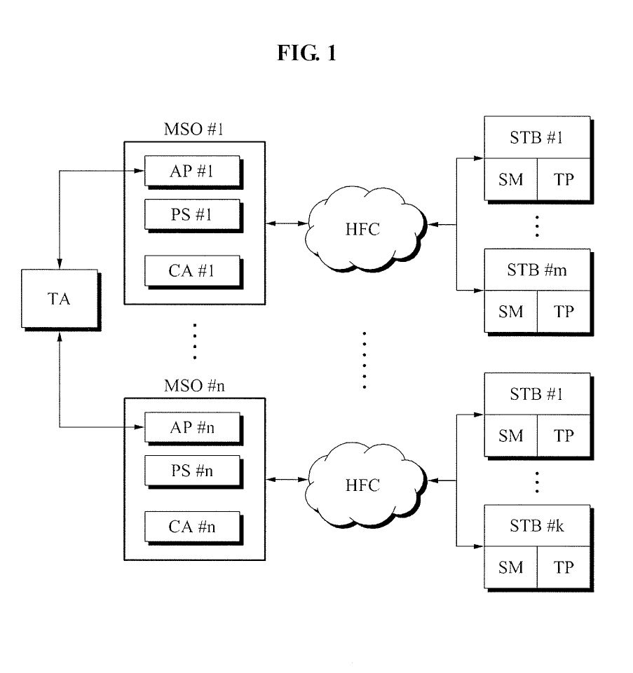

FIG. 1 is a diagram illustrating an example of a basic configuration of a Downloadable Conditional Access System (DCAS) according to an embodiment of the present invention.

As illustrated in FIG. 1, the DCAS may include a Multiple System Operator (MSO), a Trusted Authority (TA), an Authentication Proxy (AP), a Personalization Server (PS), and a Set Top Box (STB). The TA may be independently operated and perform authentication of a Secure Micro (SM) and a Transport Processor (TP) which is a descrambler. The AP may be located in the MSO, and function as a representative of the TA. The PS may manage images of application programs to be transmitted to a subscriber terminal. The STB may include the SM and the TP.

In particular, the TA and the SM may perform a critical function of the DCAS. Also, the TA may perform initialization of the SM and the TP. The SM may store and operate a Conditional Access (CA) application, a Digital Right Management (DRM) application, and an Authorized Service Domain (ASD) application, and maintain and manage information about various fee-based viewing entitlements.

According to the present invention, the above-described function of the TA may be installed in the MSO. According to an embodiment of the present invention, the MSO of the terminal authentication apparatus may perform a security authentication process without an external independent device.

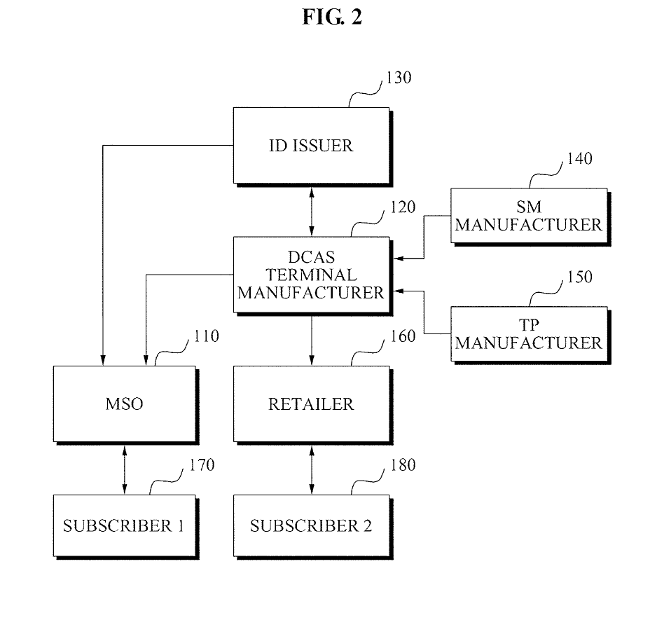

Accordingly, an operation of registration and distribution of a DCAS terminal to manage the terminal authentication apparatus in the DCAS is described in detail with reference to FIG. 2.

FIG. 2 is a diagram illustrating an example of registration and distribution of a DCAS terminal according to an embodiment of the present invention.

A DCAS terminal manufacturer 120 may be provided with an SM from an SM manufacturer 140 and a TP from a TP manufacturer 150. The SM and the TP to be installed in a DCAS terminal may require an identification (ID). For this, the DCAS terminal manufacturer 120 may request an authorized ID issuer 130 for issuance of an SM ID and a TP ID, and be provided with the SM ID and the TP ID.

In this instance, a DCAS terminal where the SM and the TP, provided with each of the IDs from the authorized ID issuer 130, are installed may be divided into a rental terminal and a terminal for purchase.

The rental terminal may denote a terminal that is manufactured by the DCAS terminal manufacturer 120 and provided to an MSO 110. Here, the MSO 110 may be plural. Also, the rental terminal may be directly provided to the MSO 110 and provided to a subscriber (1) 170 for rent.

That is, the DCAS terminal manufacturer 120 may provide the rental terminal to the MSO 110, and provide ID information of the SM and the TP installed in the DCAS terminal.

Also, the terminal for purchase may denote a DCAS terminal manufactured by the DCAS terminal manufacturer 120, and directly sold to a subscriber 180 through a retailer 160. In this instance, an authentication process may be performed when the DCAS terminal accesses an MSO network using IDs provided to an SM and a TP installed in the DCAS terminal.

The MSO 110 may be provided with ID information of the SM and the TP of the DCAS terminal from the authorized ID issuer 130, and manage the ID information. In this instance, a message transmitted and received during the above-described process may be transmitted and received through a channel where confidentiality, reliability, and message authentication are guaranteed.

According to the present invention, two types of terminal authentication apparatuses and methods may be provided depending on a virgin state. Here, the virgin state may indicate a state when a user using a DCAS terminal initially accesses an MSO.

Hereinafter, the terminal authentication apparatus and method in the virgin state is described in an aspect of the MSO.

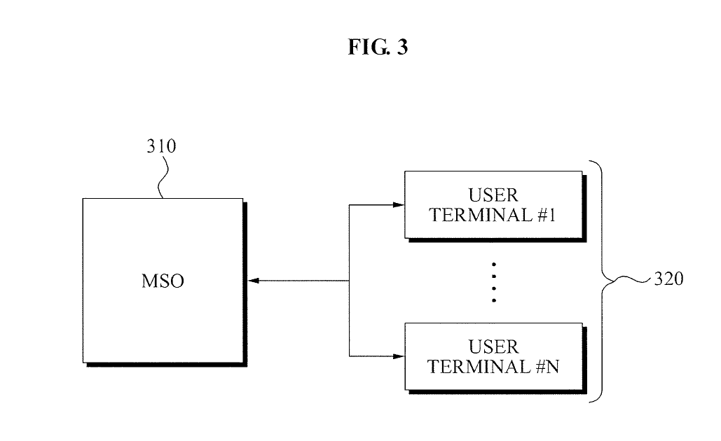

FIG. 3 is a diagram illustrating a configuration of a terminal authentication apparatus in a DCAS according to an embodiment of the present invention.

As illustrated in FIG. 3, an MSO 310 and at least one user terminal 320 may be included in the terminal authentication apparatus. According to an embodiment of the present invention, the at least one user terminal 320 may be a DCAS terminal, and the MSO 310 may be a cable broadcasting station.

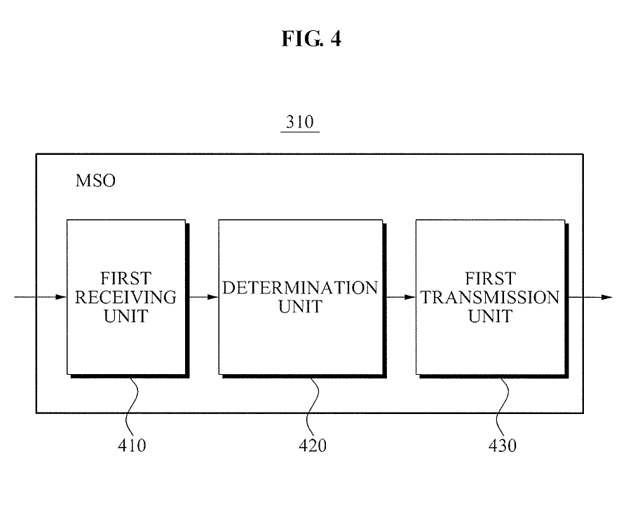

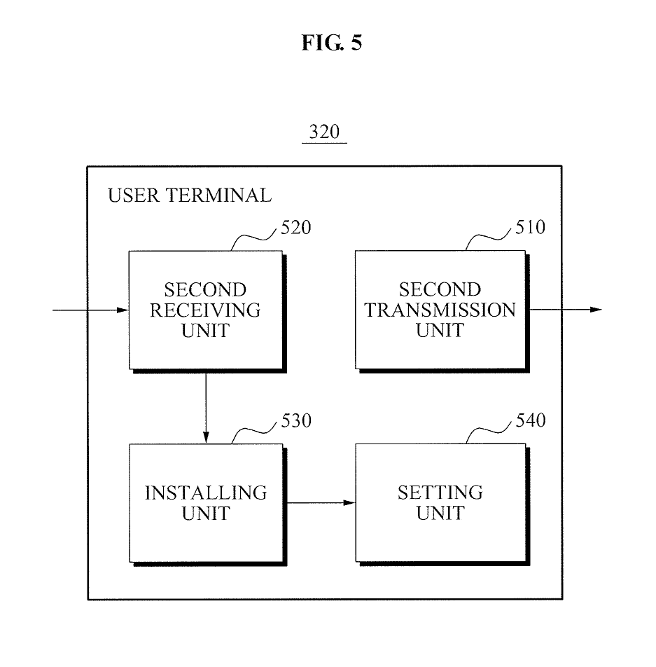

FIG. 4 is a diagram illustrating a configuration of the MSO 310 of the terminal authentication apparatus of FIG. 3. FIG. 5 is a diagram illustrating a configuration of each of the at least one user terminal 320 of the terminal authentication apparatus of FIG. 3.

According to an embodiment of the present invention, the following operations may be performed in a virgin state when the at least one user terminal 320, hereinafter referred to as the user terminal 320, initially accesses a first receiving unit 410 of the MSO 310.

As illustrated in FIGS. 4 and 5, a second transmission unit 510 of the user terminal 320 may transmit terminal authentication information, and the first receiving unit 410 of the MSO 310 may receive the terminal authentication information from the user terminal 320.

In this instance, the terminal authentication information may indicate information associated with authentication of the DCAS terminal, and include SM information and TP information of the user terminal 320.

A determination unit 420 of the MSO 310 may determine whether the terminal authentication information is valid by referring to a database.

In this instance, the database may be provided with ID information of the terminal authentication information of the user terminal 320 from an authorized ID issuance device, that is, the authorized ID issuer 130, and maintain the ID information. That is, the determination unit 420 may determine whether the terminal authentication information is valid by referring to the ID information.

Also, when the terminal authentication information is not valid, the determination unit 420 may prevent a service from being provided to the user terminal 320.

When the terminal authentication information is valid, a first transmission unit 430 of the MSO 310 may transmit DCAS image information and pairing information about the terminal authentication information to the user terminal 320.

Subsequently, a second receiving unit 520 of the user terminal 320 may receive the DCAS image information and the pairing information.

A user using the user terminal 320 may install the received DCAS image information in the user terminal 320 using an installing unit 530, and set the user terminal 320 based on the pairing information using a setting unit 540.

In this instance, all messages transmitted and received during the above-described operations may be transmitted and received through a channel where confidentiality, integrity, and message authentication are guaranteed.

Hereinafter, a terminal authentication apparatus and method according to another embodiment of the present invention is described in an aspect of an MSO, where a user terminal has previously accessed a random MSO network, and downloaded particular DCAS image information, that is, where a user terminal is not in a virgin state.

In this case, the user terminal may be rebooted within a service area of the same MSO, or may move to a service area of another MSO.

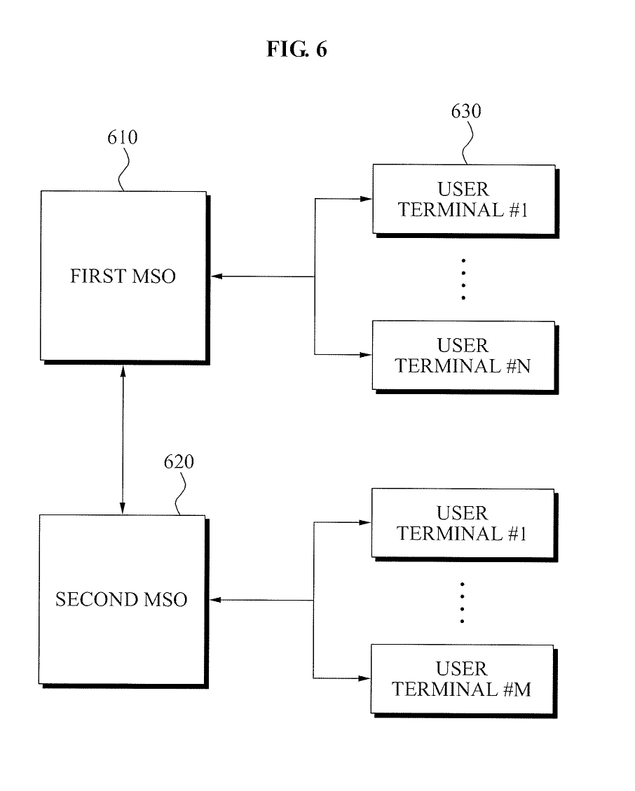

FIG. 6 is a diagram illustrating a configuration of a terminal authentication apparatus in a DCAS according to another embodiment of the present invention.

As illustrated in FIG. 6, the terminal authentication apparatus may include a first MSO 610, a second MSO 620, and at least one user terminal 630. According to another embodiment of the present invention, the at least one user terminal 630 may be a DCAS terminal, and each of the first MSO 610 and the second MSO 620 may be a cable broadcasting station.

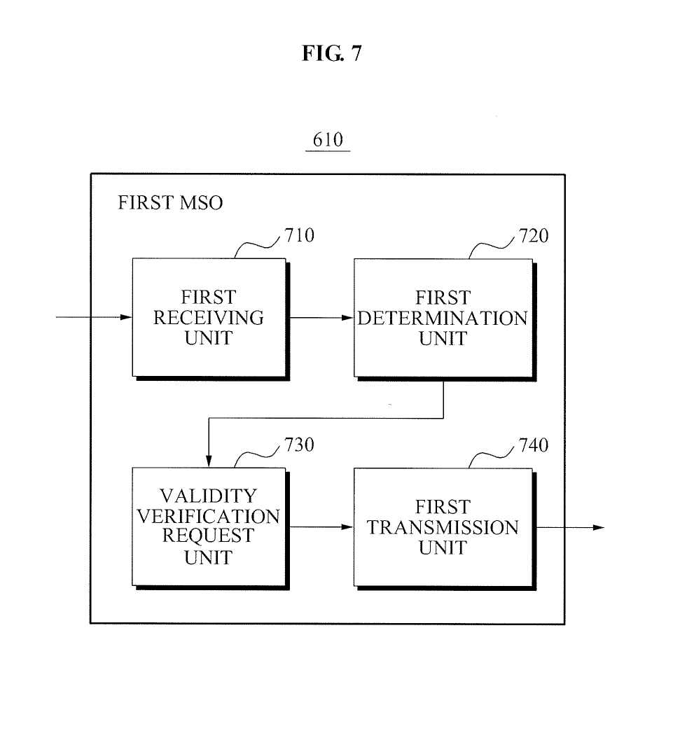

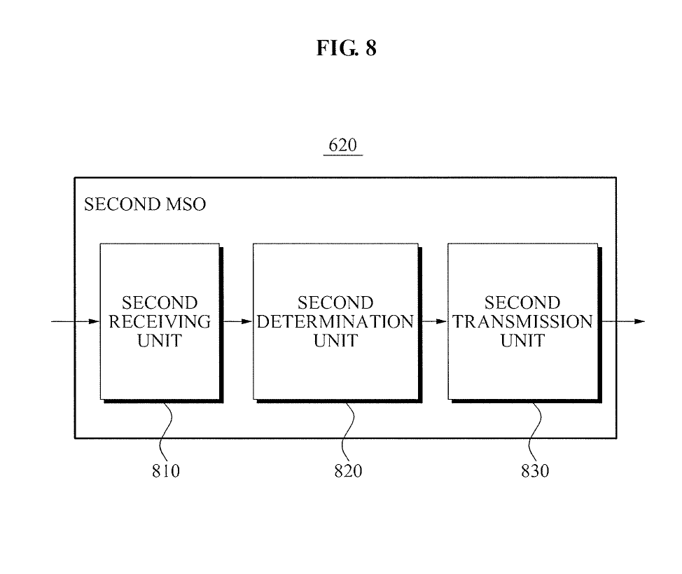

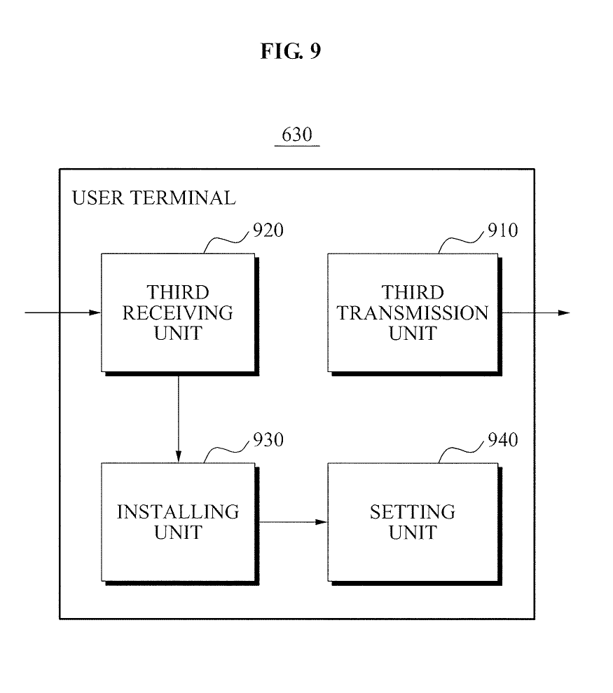

FIG. 7 is a diagram illustrating a configuration of the first MSO 610 of the terminal authentication apparatus of FIG. 6. FIG. 8 is a diagram illustrating a configuration of the second MSO 620 of the terminal authentication apparatus of FIG. 6. FIG. 9 is a diagram illustrating a configuration of the at least one user terminal 630 of the terminal authentication apparatus of FIG. 6.

According to another embodiment of the present invention, the following operations may be performed in a virgin state when the at least one user terminal 630 initially accesses a first receiving unit 710 of the first MSO 610.

A third transmission unit 910 of the at least one user terminal 630, that is, any one of the at least one user terminal 630, may transmit terminal authentication information to the first receiving unit 710. The first receiving unit 710 of the first MSO 610 may receive the terminal authentication information from the user terminal 630.

In this instance, the terminal authentication information may include SM information and TP information of the user terminal 630.

A first determination unit 720 of the first MSO 610 may determine whether the terminal authentication information is valid by referring to a first database.

In this instance, when the terminal authentication information is valid, the first determination unit 720 may control a first transmission unit 740 to transmit DCAS image information and pairing information about the terminal authentication information to the user terminal 630.

When the terminal authentication information is not valid, the first determination unit 720 may control a validity verification request unit 730 to request the second MSO 620 for a validity verification of the terminal authentication information. Here, the second MSO 620 may correspond to the terminal authentication information. In this instance, the validity verification request unit 730 may request the validity verification of the terminal authentication information based on a Secure Sockets Layer (SSL) scheme.

In this instance, a second receiving unit 810 of the second MSO 620 may receive the terminal authentication information.

Also, a second determination unit 820 of the second MSO 620 may determine whether the terminal authentication information is valid by referring to a second database. When the terminal authentication information is valid, a second transmission unit 830 may transmit validity verification information to the first receiving unit 710. The validity verification information may determine that the terminal authentication information is valid.

That is, when the validity verification information is received from the second MSO 620, the first determination unit 720 of the first MSO 610 may control the first transmission unit 740 to transmit DCAS image information and pairing information about the terminal authentication information to the user terminal 630.

According to another embodiment of the present invention, the first database and the second database may be provided with ID information of the terminal authentication information of the user terminal 630 from an authorized ID issuance device, and maintain the ID information. That is, the first determination unit 720 and the second determination unit 820 may determine whether the terminal authentication information is valid by referring to the ID information.

A third receiving unit 920 of the user terminal 630 may receive the DCAS image information and the pairing information. Also, an installing unit 930 may install the received DCAS image information, and a setting unit 940 may set the user terminal 630 based on the pairing information.

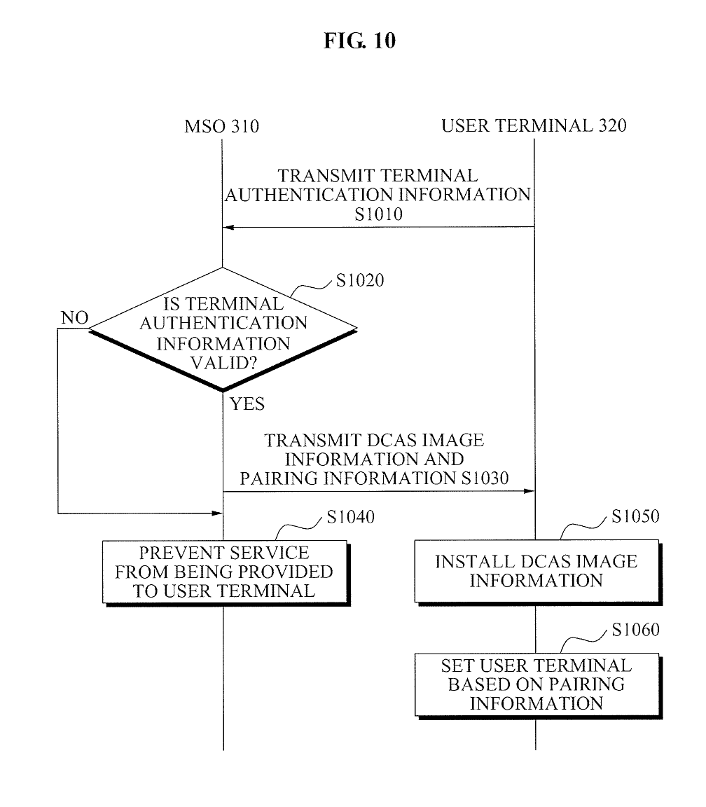

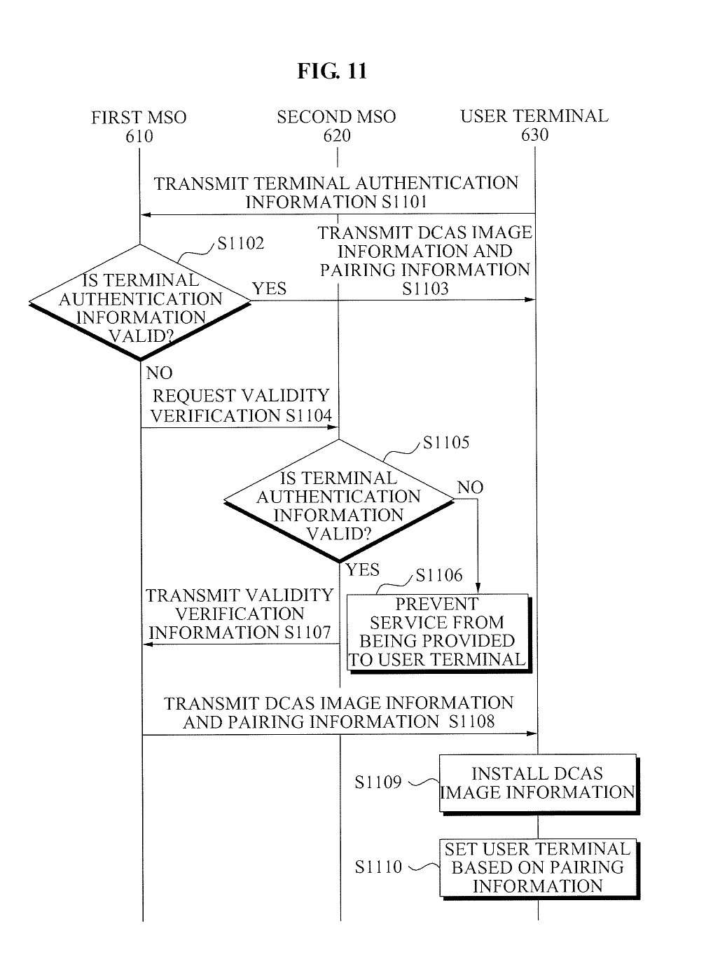

Terminal authentication methods that may vary depending on a virgin state may be provided, which is described with reference to FIGS. 10 and 11.

A terminal authentication method in a virgin state when a user terminal initially accesses an MSO is described in detail.

FIG. 10 is a flowchart illustrating a terminal authentication method in a DCAS according to an embodiment of the present invention.

In operation S1010, a user terminal 320 may transmit terminal authentication information to an MSO 310.

In operation S1020, the MSO 310 may determine whether the terminal authentication information is valid by referring to a database.

In operation S1030, when the terminal authentication information is valid, the MSO 310 may transmit DCAS image information and pairing information about the terminal authentication information to the user terminal 320.

In operation S1040, when the terminal authentication information is not valid, the MSO 310 may prevent a service from being provided to the user terminal 320.

In operation S1050, the user terminal 320 may install the received DCAS image information in the user terminal 320. In operation S1060, the user terminal 320 may set the user terminal 320 based on the pairing information.

A terminal authentication method in a non-virgin state is described in detail below.

FIG. 11 is a flowchart illustrating a terminal authentication method in a DCAS according to another embodiment of the present invention.

In operation S1101, a user terminal 630 may transmit terminal authentication information to a first MSO 610.

In operation S1102, the first MSO 610 may determine whether the terminal authentication information is valid by referring to a first database of the first MSO 610.

In operation S1103, when the terminal authentication information is valid, the first MSO 610 may transmit DCAS image information and pairing information about the terminal authentication information to the user terminal 630.

In operation S1104, when the terminal authentication information is not valid, the first MSO 610 may request a second MSO 620 for a validity verification of the terminal authentication information. The second MSO 620 may correspond to the terminal authentication information.

In operation S1105, the second MSO 620 may determine whether the terminal authentication information is valid by referring to a second database of the second MSO 620.

In operation S1106, the second MSO 620 may prevent a service from being provided to the user terminal 630, when the terminal authentication information is not valid.

In operation S1107, when the terminal authentication information is valid, the second MSO 620 may transmit validity verification information to the first MSO 610. The validity verification information may determine that the terminal authentication information is valid.

In operation S1108, when the validity verification information is received, the first MSO 610 may transmit DCAS image information and pairing information about the terminal authentication information to the user terminal 630.

In operation S1109, the user terminal 630 may install the received DCAS image information in the user terminal 630. In operation S1110, the user terminal 630 may set the user terminal 630 based on the pairing information.

According to the present invention, a terminal authentication apparatus and method may operate a DCAS even when a TA function is performed in each MSO.

Also, according to the present invention, a terminal authentication apparatus and method may provide information through a channel where confidentiality, integrity, and message authentication are guaranteed, and thereby may provide an improved security and authentication.

The terminal authentication method according to the above-described example embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A terminal authentication apparatus in a Downloadable Conditional Access System (DCAS), the terminal authentication apparatus comprising:
a first receiving unit to receive terminal authentication information from at least one user terminal;
a determination unit to determine whether the terminal authentication information is valid by referring to a database; and
a first transmission unit to transmit DCAS image information and pairing information about the terminal authentication information to the at least one user terminal, when the terminal authentication information is valid.

2. The terminal authentication apparatus of claim 1, wherein the terminal authentication information includes Secure Micro (SM) information and Transport Processor (TP) information of the at least one user terminal, the TP being a descrambler.

3. The terminal authentication apparatus of claim 1, wherein the database is provided with identification (ID) information of the terminal authentication information of the at least one user terminal from an authorized ID issuance device, and maintains the ID information, and
the determination unit determines whether the terminal authentication information is valid by referring to the ID information.

4. The terminal authentication apparatus of claim 2, wherein, when the terminal authentication information is invalid, the determination unit prevents a service from being provided to the at least one user terminal.

5. A terminal authentication apparatus in a DCAS, the terminal authentication apparatus comprising:
a first receiving unit to receive terminal authentication information from at least one user terminal;
a first determination unit to determine whether the terminal authentication information is valid by referring to a first database;
a validity verification request unit to request a Multiple System Operator (MSO) for a validity verification of the terminal authentication information, when the terminal authentication information is invalid, the MSO corresponding to the terminal authentication information; and
a first transmission unit to transmit DCAS image information and pairing information about the terminal authentication information to the at least one user terminal, when validity verification information is received from the MSO, the validity verification information determining that the terminal authentication information is valid.

6. The terminal authentication apparatus of claim 5, wherein the first determination unit controls the DCAS image information and the pairing information about the terminal authentication information to be transmitted to the at least one user terminal, when the terminal authentication information is valid.

7. The terminal authentication apparatus of claim 5, wherein the MSO comprises:
a second receiving unit to receive the terminal authentication information;
a second determination unit to determine whether the terminal authentication information is valid by referring to a second database; and
a second transmission unit to transmit the validity verification information to the first receiving unit, when the terminal authentication information is valid.

8. The terminal authentication apparatus of claim 7, wherein the first database and the second database are provided with ID information of the terminal authentication information of the at least one user terminal from an authorized ID issuance device and maintains the ID information, and
the first determination unit and the second determination unit determine whether the terminal authentication information is valid by referring to the ID information.

9. The terminal authentication apparatus of claim 5, wherein the validity verification request unit requests the validity verification of the terminal authentication information based on a Secure Sockets Layer (SSL) scheme.

10. A terminal authentication method in a DCAS, the terminal authentication method comprising:
transmitting, by at least one user terminal, terminal authentication information to an MSO;
determining, by the MSO, whether the terminal authentication information is valid by referring to a database;
transmitting, by the MSO, DCAS image information and pairing information about the terminal authentication information to the at least one user terminal, when the terminal authentication information is valid;
installing the received DCAS image information in the at least one user terminal; and
setting the at least one user terminal based on the pairing information.

11. A terminal authentication method in a DCAS, the terminal authentication method comprising:
transmitting, by at least one user terminal, terminal authentication information to a first MSO;
determining whether the terminal authentication information is valid by referring to a first database of the first MSO;
requesting a second MSO for a validity verification of the terminal authentication information, when the terminal authentication information is invalid, the second MSO corresponding to the terminal authentication information;
determining whether the terminal authentication information is valid by referring to a second database of the second MSO;
transmitting, by the second MSO, validity verification information to the first MSO, when the terminal authentication information is valid, the validity verification information determining that the terminal authentication information is valid;
transmitting, by the first MSO, DCAS image information and pairing information about the terminal authentication information to the at least one user terminal, when the validity verification information is received;
installing the received DCAS image information in the at least one user terminal; and
setting the at least one user terminal based on the pairing information.
